(19) United States
(12) Patent Application Publication
(10) Pub. No.: US 2017/0293859 A1
(43) Pub. Date: Oct. 12, 2017

(54) METHOD FOR TRAINING A RANKER MODULE USING A TRAINING SET HAVING NOISY LABELS

(71) Applicant: YANDEX EUROPE AG, Luzem (CH)

(72) Inventors: Gleb Gennadievich GUSEV, Moscow (RU); Yury Mikhailovich USTINOVSKIY, Moscow (RU); Pavel Viktorovich SERDYUKOV, Moscow (RU); Valentina Pavlovna FEDOROVA, Sergiev Posad (RU)

(21) Appl. No.: 15/472,363

(22) Filed: Mar. 29, 2017

(30) Foreign Application Priority Data
Apr. 11, 2016 (RU) 2016113685

(51) Int. Cl. G06N 99/00; G06F 17/30

(52) U.S. Cl. CPC G06N 99/005; G06F 17/3053

(57) ABSTRACT

There is disclosed a computer implemented method for training a search ranker, the search ranker being configured to ranking search results. The method comprises: retrieving, by the server, a training dataset including a plurality of training objects; for each training object, based on the corresponding associated object feature vector: determining a weight parameter, the weight parameter being indicative of a quality of the label; determining a relevance parameter, the relevance parameter being indicative of a moderated value of the labels relative to other labels within the training dataset; training the search ranker using the plurality of training objects of the training dataset, the determined relevance parameter for each training object of the plurality of training objects of the training dataset, and the determined weight parameter for each object of the plurality of training objects of the training dataset to rank a new document.

### CROSS-REFERENCE

The present application claims priority to Russian Patent Application No. 2016113685, filed Apr. 11, 2016, entitled “METHOD FOR TRAINING A RANKER MODULE USING A TRAINING SET HAVING NOISY LABELS”, the entirety of which is incorporated herein by reference.

### TECHNICAL FIELD

The present technology relates to methods and systems for training a ranker module in general and, more specifically, to a method and a system for training a ranker module using a training set having noisy labels.

### BACKGROUND

With ever increasing amount of data stored at various servers, the task of efficient searching becomes an ever-more imperative one. Taking an example of the Internet, there are millions and millions of resources available on the Internet and several search engines (such as, GOOGLE™, YAHOO™, YANDEX™, BAIDU™ and the like) aim to provide users with a convenient tool for finding relevant information that is responsive to the user's search intent.

A typical search engine server executes a crawling function. More specifically, the search engine executes a robot that “visits” various resources available on the Internet and indexes their content. Specific algorithms and schedules for the crawling robots vary, but on the high level, the main goal of the crawling operation is to (i) identify a particular resource on the Internet, (ii) identify key themes associated with the particular resource (themes being represented by key words and the like), and (iii) index the key themes to the particular resource.

Once a search query from a user is received by the search engine, the search engine identifies all the crawled resources that are potentially related to the user's search query. The search engine then executes a search ranker to rank the so-identified potentially relevant resources. The key goal of the search ranker is to organize the identified search results by placing potentially most relevant search results at the top of the search engine results list. Search rankers are implemented in different manners, some employing Machine Learning Algorithms (MLAs) for ranking search results.

A typical MLA used by the search rankers is trained using training datasets of query-document pairs, where each query-document pair is associated with a relevance parameter. A given query-document pair contains a training search query and a given document (such as a web resource) potentially relevant (or responsive) to the training search query. The relevancy label is indicative of how accurately the given document reflects the search intent of the training search query (i.e. how responsive the content of the given document is to the training search query or, in other words, how likely the content of the given document is likely to satisfy the user search intent associated with the training search query).

Typically, the training datasets are marked by “assessors”, who assign relevancy labels to the query-document pairs using a human judgment. Assessors are rigorously trained to assign labels to the query-document pair to ensure consistency of the labels amongst different assessors. Assessors are provided with very strict guidance as to how to assign label value to the given query-document pair (such as detailed description of each label, what represents a highly relevant documents, what represents a document with a low relevance, etc).

Despite such close control of the labelling of the query-document pairs, the labels assigned by professional assessors can be “noisy”—in the sense that the labels assigned to a given query-document pair by different assessors can be markedly different. Some assessors tend to be very conservative (i.e. assign good scores to only very relevant documents), while other assessors can be more lenient in their score assignments.

A recent trend in training search rankers is use of “crowd-sourced” training datasets, which have been believed to provide a fast and inexpensive alternative to training datasets manually labelled by professional assessors. However the relevance parameters acquired by crowd-sourcing (crowd labels) can be “noisy” due to various factors such as variation in the quality of the crowd worker, ambiguity in the instructions for the labeling task given to the crowd-sourcing participants and such.

Irrespective of the type of the noise, the noise in the labelling of sample can affect the ranking quality of the search ranker. In order to deal with the noise in training datasets (specifically but not limited to the crowd-sourced training datasets), various crowd consensus models are used in association with the crowd-sourced training datasets for training ranking algorithms.

### SUMMARY

It is an object of the present to ameliorate at least some of the inconveniences present in the prior art.

Embodiments of the present technology have been developed based on developers' appreciation of at least one technical problem associated with the prior art solutions. Developers have appreciated whereby professionally-assigned labels could have been noisy, the level of noise within crowd-sourced training sets is even greater than that of professional-assessors-labelled training sets.

Without wishing to be bound by any specific theory, developers of the present technology believe that crowd-sourced training datasets may be suffering from an increased level of noise due to at least some of the following (but not being so limited): (1) crowd-sourcing participants are usually not provided with detailed instructions like those compiled for professional assessors, since the majority of crowd-sourcing participants are believed to either refuse or fail to follow the more complicated guidelines; (2) partly due to this, individual crowd-sourcing participants vary greatly in the quality of their assessments; (3) a large number of crowd-sourcing participants are spammers, answering randomly or using simple quality agnostic heuristics.

Developers further believe that traditional approaches to noise reduction in labelled training set may not be effective for crowd-source labelled training sets. For example, common approaches to noise reduction include cleansing and weighting techniques. Noise cleansing techniques are similar to “outlier detection” and amount to filtering out samples which “look like” mislabeled for some reason. With the weighting approach none of the samples are completely discarded, while their impact on a machine learning algorithm is controlled by weights, representing our confidence in a particular label.

In the setting of crowd-sourced labeling, one can modify the labeling process in order to gain some evidence for each label being correct. Namely, the overseers of the crowd-sourcing participants typically: (1) provide simplistic labeling instructions, much simpler than in the case of professional assessors (such as on the scale of 1 or 2, instead of a scale of 1 to 5, as an example); (2) place ‘honeypot’ tasks, i.e., tasks with a known true label; (3) assign each task to multiple workers in order to evaluate and aggregate their answers.

The presence of honeypots and multiple labels for each query-document pair in the dataset allows one to use certain crowd consensus models. These models infer a single consensus label for each task, providing more accurate labels than those generated by individual crowd-sourcing participants. Consensus models make additional assumptions on the distributions of errors among labels and crowd-sourcing participants (assessors) and derive certain quantities that estimate the probabilities of labels being correct. The simplest examples of consensus models are ‘majority vote’ and ‘average score’, which assign the most frequent/average score to each query-document pair.

Even though crowd-sourced labels consensus models could be used to purify learning to rank datasets by substituting crowd-sourced labels with consensus labels or by discarding particular crowd-sourced labels with low confidence in their quality, developers of the present technology believe that such an approach would suffer from certain drawbacks. Since the objective of a consensus model is accuracy of output labels, and optimizing the accuracy of labels, one does not necessarily optimize the quality of a ranker, trained on the dataset purified by the consensus model. In fact, certain experiments conducted by the developers led them to believe that a straightforward utilization of consensus labels within a learning to rank algorithm results in suboptimal rankers.

There is another aspect, which is usually not captured by the existing consensus models. Often, assessor instructions are simplified (e.g., a 5-grade scheme is reduced to a 2-grade scheme) to easier attract non-professional assessors from crowdsourcing platforms. Unfortunately, while such simplification allows attracting more crowd-sourcing participants, it also introduces a bias into their judgements, as the crowd-sourcing participants become much less precise and expressive. For instance, some crowd-sourcing participants are more conservative than the others, thus their positive labels should imply higher relevance than the positive labels of crowd-sourcing participants who assign them less reservedly.

Hence, developers of the present technology address the above-discussed drawbacks associated with the crowd-sourced training sets by developing a pre-processing routine for crowd-sourced labels. Broadly speaking, the pre-processing routine includes (i) relevancy normalization of labels and (ii) weighting of relevancy-normalized labels.

More specifically, embodiments of the present technology, broadly speaking, are directed to a machine learning based algorithm that assigns to each training set sample (1) its relevance value (which in a sense normalized the label) and (2) its weight (which in a sense captures the confidence in the value). These two parameters are modelled as respective functions of label features, which may include the outputs of various consensus models, statistics on a given task, crowd label itself, etc. Embodiments of the present technology include training both functions (one for the relevance value and one for the weight).

Embodiments of the present technology can be used with any type of the learning to rank algorithm. A technical effect of the present technology is believed to lie in the fact that the embodiments of present technology directly optimize the ranking quality achieved by the associated learning to rank algorithm.

In accordance with a first broad aspect of the present technology, there is provided a computer implemented method for training a search ranker, the search ranker being configured to ranking search results. The method is executable at a server associated with the search ranker. The method comprises: retrieving, by the server, a training dataset including a plurality of training objects, each training object within the training dataset having been assigned a label and being associated with an object feature vector; for each training object, based on the corresponding associated object feature vector: determining a weight parameter, the weight parameter being indicative of a quality of the label; determining a relevance parameter, the relevance parameter being indicative of a moderated value of the labels relative to other labels within the training dataset; training the search ranker using the plurality of training objects of the training dataset, the determined relevance parameter for each training object of the plurality of training objects of the training dataset, and the determined weight parameter for each object of the plurality of training objects of the training dataset to rank a new document.

In some implementations of the method, the training dataset is a crowd-sourced training dataset.

In some implementations of the method, the training dataset is a crowd-sourced training dataset and wherein each training object within the training dataset has been assigned the label by a crowd-sourcing participant.

In some implementations of the method, the object feature vector is based, at least in part, on data associated with the crowd-sourcing participant assigning the label to a given training object.

In some implementations of the method, the data is representative of at least one of: browsing activities of the crowd-sourcing participant, time interval spent reviewing the given training object, experience level associated with the crowd-sourcing participant, a rigor parameter associated with the crowd-sourcing participant.

In some implementations of the method, the object feature vector is based, at least in part, on data associated with ranking features of a given training object.

In some implementations of the method, the method further comprises learning a relevance parameter function for determining the relevance parameter for each training object using the corresponding associated object feature vector by optimizing a ranking quality of the search ranker.

In some implementations of the method, the method further comprises learning a weight function for determining the weight label for each training object based on the corresponding associated object feature vector by optimizing a ranking quality of the search ranker.

In some implementations of the method, the relevance parameter is determined by a relevance parameter function; the weight label is determined by a weight function; the relevance parameter function and the weight function having been independently trained.

In some implementations of the method, the search ranker is configured to execute a machine learning algorithm and wherein training the search ranker comprises training the machine learning algorithm.

In some implementations of the method, the machine learning algorithm is based on one of a supervised training and a semi-supervised training.

In some implementations of the method, the machine learning algorithm is one of a neural network, a decision tree-based algorithm, association rule learning based MLA, a Deep Learning based MLA, an inductive logic programming based MLA, a support vector machines based MLA, a clustering based MLA, a Bayesian network, a reinforcement learning based MLA, a representation learning based MLA, a similarity and metric learning based MLA, a sparse dictionary learning based MLA, and a genetic algorithms based MLA.

In some implementations of the method, the training is based on a target of directly optimizing quality of the search ranker.

In some implementations of the method, the method further comprises calculating the object feature vector based on a plurality of object features.

In some implementations of the method, the plurality of object features including at least ranking features and label features, and wherein the method further comprises organizing object features in a matrix with matrix rows representing ranking features and matrix columns representing label features.

In some implementations of the method, the calculating the object feature vector comprises calculating an objective feature based on the matrix.

In accordance with another broad aspect of the present technology, there is provided a training server for training a search ranker, the search ranker server for ranking search results. The training server comprises: a network interface for communicatively coupling to a communication network; a processor coupled to the network interface, the processor configured to: retrieve a training dataset including a plurality of training objects, each training object within the training dataset having been assigned a label and being associated with an object feature vector; for each training object, based on the corresponding associated object feature vector: determine a weight parameter, the weight parameter being indicative of a quality of the label; determine a relevance parameter, the relevance parameter being indicative of a moderated value of the labels relative to other labels within the training dataset; train the search ranker using the plurality of training objects of the training dataset, the determined relevance parameter for each training object of the plurality of training objects of the training dataset, and the determined weight parameter for each object of the plurality of training objects of the training dataset to rank a new document.

In some embodiments of the training server, the training server and the search ranker can be implemented as a single server.

In the context of the present specification, unless expressly provided otherwise, an “electronic device”, a “user device”, a “server”, and a “computer-based system” are any hardware and/or software appropriate to the relevant task at hand. Thus, some non-limiting examples of hardware and/or software include computers (servers, desktops, laptops, netbooks, etc.), smartphones, tablets, network equipment (routers, switches, gateways, etc.) and/or combination thereof.

In the context of the present specification, unless expressly provided otherwise, the expression “computer-readable medium” and “storage” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a system suitable for implementing non-limiting embodiments of the present technology.

FIG. 2 depicts a schematic representation of the training phases (a training phase, an in-use phase, and a validation sub-phase) of a machine learning algorithm employed by a ranking application of the system of FIG. 1.

FIG. 3 schematically depicts a given training object of the training dataset maintained by a training server of the system of FIG. 1.

FIG. 4 depicts a flow chart of a method for training the ranking application, the method being executable by the training server of FIG. 1, the method being executed in accordance with non-limiting embodiments of the present technology.

### DETAILED DESCRIPTION

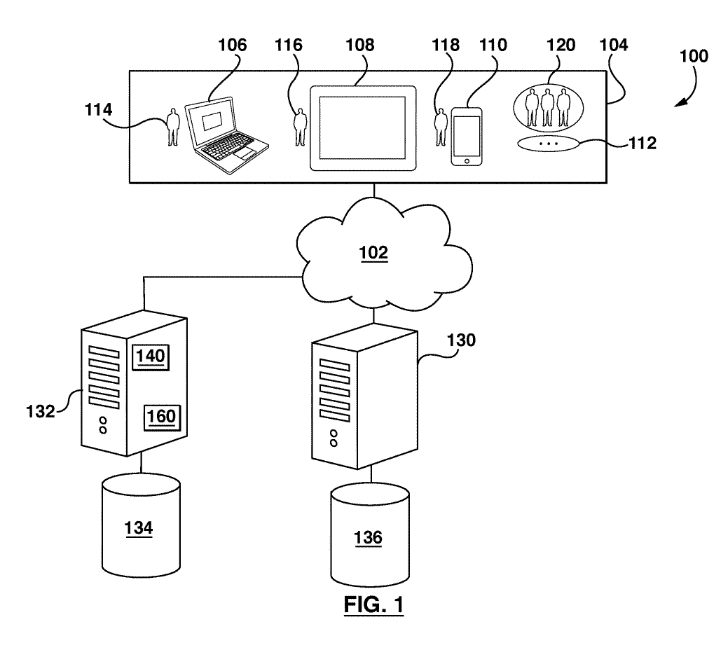

With reference to FIG. 1, there is depicted a system 100, the system implemented according to embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises a communication network 102 for providing communication between various components of the system 100 communicatively coupled thereto. In some non-limiting embodiments of the present technology, the communication network 102 can be implemented as the Internet. In other embodiments of the present technology, the communication network 102 can be implemented differently, such as any wide-area communication network, local-area communication network, a private communication network and the like. The communication network 102 can support exchange of messages and data in an open format or in an encrypted form, using various known encryption standards.

The system 100 comprises a plurality of electronic devices 104, the plurality of electronic devices 104 being communicatively coupled to the communication network 102. In the depicted embodiments, the plurality of electronic devices comprises a first electronic device 106, a second electronic device 108, a third electronic device 110 and a number of additional electronic devices 112. It should be noted that the exact number of the plurality of the electronic devices 104 is not particularly limited and, generally speaking, it can be said that the plurality of electronic devices 104 comprises at least two electronic devices such as those depicted (i.e. the first electronic device 106, the second electronic device 108, the third electronic device 110 and the number of additional electronic devices 112).

The first electronic device 106 is associated with a first user 114 and, as such, can sometimes be referred to as a “first client device”. It should be noted that the fact that the first electronic device 106 is associated with the first user 114 does not need to suggest or imply any mode of operation—such as a need to log in, a need to be registered or the like. The implementation of the first electronic device 106 is not particularly limited, but as an example, the first electronic device 106 may be implemented as a personal computer (desktops, laptops, netbooks, etc.), a wireless communication device (a cell phone, a smartphone, a tablet and the like), as well as network equipment (a router, a switch, or a gateway). Within the depiction of FIG. 1, the first electronic device 106 is implemented as the personal computer (laptop).

The second electronic device 108 is associated with a second user 116 and, as such, can sometimes be referred to as a “second client device”. It should be noted that the fact that the second electronic device 108 is associated with the second user 116 does not need to suggest or imply any mode of operation—such as a need to log in, a need to be registered or the like. The implementation of the second electronic device 108 is not particularly limited, but as an example, the second electronic device 108 may be implemented as a personal computer (desktops, laptops, netbooks, etc.), a wireless communication device (a cell phone, a smartphone, a tablet and the like), as well as network equipment (a router, a switch, or a gateway). Within the depiction of FIG. 1, the second electronic device 108 is implemented as the tablet computing device.

The third electronic device 110 is associated with a third user 118 and, as such, can sometimes be referred to as a “third client device”. It should be noted that the fact that the third electronic device 110 is associated with the third user 118 does not need to suggest or imply any mode of operation—such as a need to log in, a need to be registered or the like. The implementation of the third electronic device 110 is not particularly limited, but as an example, the third electronic device 110 may be implemented as a personal computer (desktops, laptops, netbooks, etc.), a wireless communication device (a cell phone, a smartphone, a tablet and the like), as well as network equipment (a router, a switch, or a gateway). Within the depiction of FIG. 1, the third electronic device 110 is implemented as the smartphone.

A given one of the number of additional electronic devices 112 is associated with a respective additional user 120 and, as such, can sometimes be referred to as an “additional client device”. It should be noted that the fact that the given one of the number of additional electronic devices 112 is associated with the respective additional user 120 does not need to suggest or imply any mode of operation—such as a need to log in, a need to be registered or the like. The implementation of the given one of the number of additional electronic devices 112 is not particularly limited, but as an example, the given one of the number of additional electronic devices 112 may be implemented as a personal computer (desktops, laptops, netbooks, etc.), a wireless communication device (a cell phone, a smartphone, a tablet and the like), as well as network equipment (a router, a switch, or a gateway).

Also coupled to the communication network are a training server 130 and a search ranker server 132. Even though in the depicted embodiment the training server and the search ranker server 132 are depicted as separate entities, functionality thereof can be executed by a single server.

In an example of an embodiment of the present technology, the training server 130 can be implemented as a Dell™ PowerEdge™ Server running the Microsoft™ Windows Server™ operating system. Needless to say, the training server 130 can be implemented in any other suitable hardware and/or software and/or firmware or a combination thereof. In the depicted non-limiting embodiment of present technology, the training server 130 is a single server. In alternative non-limiting embodiments of the present technology, the functionality of the training server 130 may be distributed and may be implemented via multiple servers.

In an example of an embodiment of the present technology, the search ranker server 132 can be implemented as a Dell™ PowerEdge™ Server running the Microsoft™ Windows Server™ operating system. Needless to say, the search ranker server 132 can be implemented in any other suitable hardware and/or software and/or firmware or a combination thereof. In the depicted non-limiting embodiment of present technology, the search ranker server 132 is a single server. In alternative non-limiting embodiments of the present technology, the functionality of the search ranker server 132 may be distributed and may be implemented via multiple servers.

Even though the training server 130 and the search ranker server 132 have been described using an example of the same hardware, they do not need to be implemented in the same manner therebetween.

In some embodiments of the present technology, the search ranker server 132 is under control and/or management of a search engine, such as that provided by YANDEX™ search engine of Yandex LLC of Lev Tolstoy Street, No. 16, Moscow, 119021, Russia. However, the search ranker server 132 can be implemented differently (such as a local searcher and the like). The search ranker server 132 is configured to maintain a search database 134, which contains an indication of various resources available and accessible via the communication network 102.

The process of populating and maintaining the search database 134 is generally known as “crawling” where a crawler application 140 executed by the search ranker server 132 is configured to “visit” various web sites and web pages accessible via the communication network 102 and to index the content thereof (such as associate a given web resource to one or more key words). In some embodiments of the present technology, the crawler application 140 maintains the search database 134 as an “inverted index”. Hence, the crawler application 140 of the search ranker server 132 is configured to store information about such indexed web resources in the search database 134.

When the search ranker server 132 receives a search query from a search user (such as for examples, “Cheap Hotels in Munich”), the search ranker server 132 is configured to execute a ranking application 160. The ranking application 160 is configured to access the search database 134 to retrieve an indication of a plurality of resources that are potentially relevant to the user-submitted search query (in this example, “Cheap Hotels in Munich”). The ranking application 160 is further configured to rank the so-retrieved potentially relevant resources so that they can be presented in a ranked order on a Search Engine Results Page (SERP), such that the SERP presents so-ranked more relevant resources at a top of the list.

To that end, the ranking application 160 is configured to execute a ranking algorithm. In some embodiments of the present technology, the ranking algorithm is a Machine Learning Algorithm (MLA). In various embodiments of the present technology, the ranking application 160 executed the MLA that is based on neural networks, decision tree models, association rule learning based MLA, Deep Learning based MLA, inductive logic programming based MLA, support vector machines based MLA, clustering based MLA, Bayesian networks, reinforcement learning based MLA, representation learning based MLA, similarity and metric learning based MLA, sparse dictionary learning based MLA, genetic algorithms based MLA, and the like.

In some embodiments of the present technology, the ranking application 160 employs a supervised-learning based MLA. In other embodiments, the ranking application 160 employs a semi-supervised-learning based MLA.

Within these embodiments, the ranking application 160 can be said to be used in two phases—a training phase where the ranking application 160 is “trained” to derive an MLA formula and an in-use phase where the ranking application 160 is used to rank documents using the MLA formula. The training phase also includes a validation “sub-phase”, where the MLA formula is tested and calibrated.

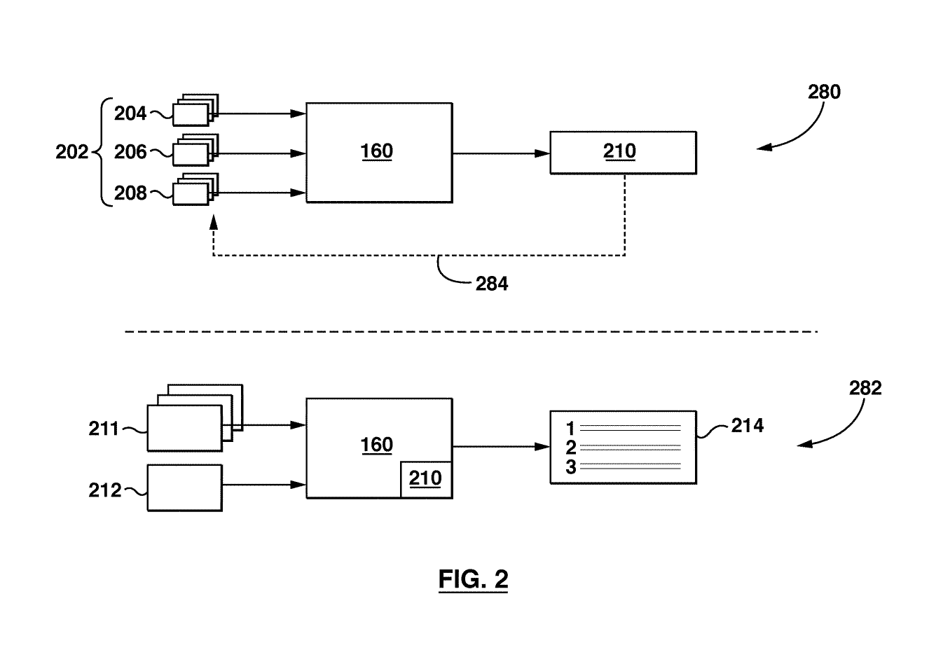

With reference to FIG. 2, the above phases are schematically depicted namely a training phase 280, an in-use phase 282 and a validation sub-phase 284.

During the training phase 280, the ranking application 160 is supplied with a training dataset 202, the training dataset 202 including a plurality of training objects—such as a first training object 204, a second training object 206, a third training object 208, as well as other training objects potentially present within the training dataset 202. It should be understood that the training dataset 202 is not limited to the first training object 204, the second training object 206, and the third training object 208 depicted within FIG. 2. And, as such, the training dataset 202 will include a number of additional training objects (such as hundreds, thousands or hundreds of thousands of additional training objects similar to the depicted ones of the first training object 204, the second training object 206, and the third training object 208).

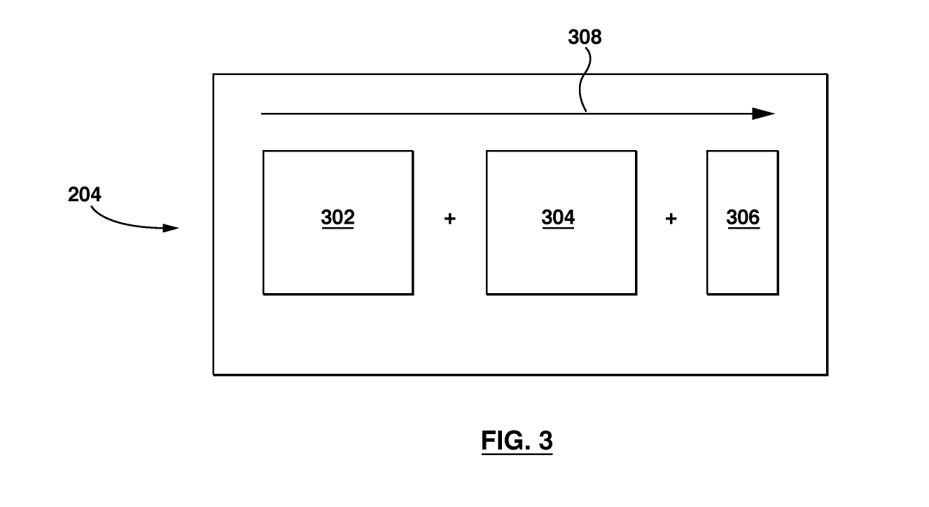

With reference to FIG. 3, which schematically depicts a given training object of the training dataset 202 (in this case, the first training object 204), using the example of the first training object 204, each training object 204, 206, 208 within the training dataset 202 comprises a query-document pair (which includes an indication of a training query 302 and an associated training document 304, which potentially is responsive to the training query 302) and an assigned label 306.

Generally speaking, the label 306 is indicative of how responsive the training document 304 is to the training query 302 (the higher the value of the label 306, the more likely that a user conducting a search query similar to the training query 302 will find the training document 304 useful for responding to the training query 302). How the label 306 is assigned will be described in greater detail herein below.

Each training object 204, 206, 208 can be also said to be associated with a respective object feature vector 308. The object feature vector 308 can be generated by the training server 130 during the training phase 280. The object feature vector 308 is representative of one or more characteristics of the associated training object 204, 206, 208. The process of generation and use of the object feature vector 308 will be described in greater detail herein below.

As part of the training phase 280, the MLA executed by the ranking application 160 analyzes the training dataset to derive a MLA formula 210, which in a sense is based on hidden relationships between various components of the training objects (i.e. the training query 302—training document 304 pair) within the training dataset 202 and the associated label 306.

During the validation sub-phase 284, the ranking application 160 is provided with a validation set of documents (not depicted), these are similar to the training dataset 202, albeit the ones that the ranking application 160 has not yet “seen”. Each query-document pair within the validation set of document is assigned a ground truth label (i.e. how good the document is for the query) and the ground truth label is compared with a prediction made by the ranking application 160. Should the ranking application 160 be wrong in the prediction, this information is fed back into the ranking application 160 for calibration of the MLA formula 210.

In the in-use phase 282, the ranking application 160 applies the so-trained MLA formula 210 to the real-time search queries submitted by the users. As such, the ranking application 160 receives an indication of a user search query 212 and a set of potentially relevant documents 211. The ranking application 160 then applies the MLA formula 210 to generate a ranked search result list 214, which includes the set of potentially relevant documents 211 specifically ranked by relevance to the user search query 212.

Returning now to the description of FIG. 1, the plurality of electronic devices 104 can be part of a training-set of electronic devices used for compiling the training dataset 202. In some embodiments, the training-set of electronic devices (i.e. the plurality of electronic devices 104) can be part of a pool of professional assessors and as such, the users (the first user 114, the second user 116, the third user 118 and the respective additional users 120) can all be professional assessors. Alternatively, the training-set of electronic devices (i.e. the plurality of electronic devices 104) can be part of a pool of crowd-sourcing assessors and as such, the users (the first user 114, the second user 116, the third user 118 and the respective additional users 120) can all be crowd-sourcing participants.

In yet additional embodiments, the training-set of electronic devices (i.e. the plurality of electronic devices 104) can be part split—some of the plurality of electronic devices 104 can be part of the professional assessors and some of the training-set of electronic devices (i.e. the plurality of electronic devices 104) can be part of a pool of crowd-sourcing assessors. As such, some of the users (the first user 114, the second user 116, the third user 118 and the respective additional users 120) can be professional assessors; while others of the users (the first user 114, the second user 116, the third user 118 and the respective additional users 120) can be crowd-sourcing participants.

In some embodiments of the present technology, the crowd-sourcing participants can be based on a YANDEXTOLOKA™ platform (such as toloka.yandex.com). However, any commercial or proprietary crowd-sourcing platform can be used.

Each user (each of the first user 114, the second user 116, the third user 118 and the respective additional users 120) is presented with a given training object 204, 206, 208 and the user assign the label 306. The label 306 is representative of how relevant the given training document 304 is to the given training query 302. Depending on specific implementations, the users (the first user 114, the second user 116, the third user 118 and the respective additional users 120) are provided with labelling instructions, such as but not limited to:

a scale of “1” to “5”,

a scale of “1” to “2”,

a scale of “1” to “10”,

a scale of “good” and “bad”,

a scale of “low relevancy”, “medium relevancy” and “ high relevancy”,

a scale of “Perfect-Excellent-Good-Fair-Bad”,

etc.

In some embodiments of the present technology, the training server 130 can store an indication of the given training object 204, 206, 208 and the associated assigned label 306 in a training object database 136, coupled to or otherwise accessible by the training server 130.

In accordance with embodiments of the present technology, the training server 130 is further configured to pre-process the training objects 204, 206, 208 of the training dataset 202 and the respective labels 306 assigned thereto.

For a given training object 204, 206, 208 the training server 130 is configured to generate a weight parameter and a relevance parameter. In accordance with embodiments of the present technology, the weight parameter is indicative of a quality of the given label 306 and the relevance parameter being is indicative of a moderated value of the give labels 306 relative to other labels 306 within the training dataset 202.

Embodiments of the present technology are based on developers' appreciation that a quality of the given label 306 is generally based on at least two quantities: the actual quality of the given training document 304 (i.e. how relevant it is to the training query 302) and a rigor parameter associated with the given assessor/crowd-sourcing participant.

For example, the most conservative assessor/crowd-sourcing participant (having a high value of the rigor parameter) assigns a positive version of the label 306 only to a perfect result (i.e. the given training document 304 that the given assessor/crowd-sourcing participant believes to be highly relevant to the training query 302). Another assessor/crowd-sourcing participant, who is less rigorous (having a comparatively lower value of the rigor parameter) assigns a positive version of the label 306 to both good and perfect documents (i.e. the given training document 304 that the given assessor/crowd-sourcing participant believes to be highly or just relevant to the training query 302).

Without wishing to be bound to any specific theory, embodiments of the present technology are based on the premise that the higher the rigor parameter associated with a given assessor/crowd-sourcing participant, the higher weight parameter should be assigned to the label 306 generated by the given assessor/crowd-sourcing participant.

Embodiments of the present technology are further based on a further premise that the quality of object labeling varies across different assessors/crowd-sourcing participants and tasks. For example, confidence in a particular label 306 can be low (for example, due to some or all of: assessors/crowd-sourcing participants who labeled the given training object 204, 206, 208 makes many mistakes on honeypots; the given label 306 contradicts the other labels assigned by other assessors/crowd-sourcing participants working on the same given training object 204, 206, 208, etc).

In accordance with embodiments of the present technology, such a given label 306 needs to have less impact on the ranking application 160. Embodiments of the present technology account for this impact by the weight parameter. So the larger the confidence in the label 306 is, the larger should be its corresponding weight.

In accordance with various embodiments, the training server 130 assigns the weight parameter to the given label 306 (and, thus, the given training object 204, 206, 208) based on at least one of: the rigor parameter associated with the assessor/crowd-sourced participant, the quality parameter associated with the assessor/crowd-sourced participant and other parameters represented in the object feature vector 308.

On the other hand, a certain assessor/crowd-sourced participant can be more conservative than the other one of the assessor/crowd-sourced participant. For instance, a given assessor/crowd-sourced participant can assign a positive label 306 only to ‘perfect’ query-document pairs, while another assessor/crowd-sourced participant assigns a positive label to each query-document pair, unless it is completely irrelevant.

In this case, embodiments of the present technology put a greater value on the label 306 assigned by an earlier assessor/crowd-sourced participant than the label 306 assigned by the latter assessor/crowd-sourced participant. This is reflected in the relevance parameter assigned to the given label 306, the relevance parameter being representative of a remapped (or “moderated”) value of the given label 306.

In some embodiments of the present technology, the training server 130 can transform the weight parameter and the relevance parameter using a sigmoid transform, which ensures that all weight parameters and the relevance parameters fall into unit interval of [0,1].

Example Training Dataset 202

As an example for the non-limiting embodiments, the given training dataset 202 can be implemented as follows.

The example training dataset 202 can include 7200 training objects 204, 206, 208. Within the example training dataset 202, there can be 132,000 query-document pairs to be assessed by the crowd-sourcing participants and/or professional assessors. The labels 306 may have been assigned by 1720 crowd-sourcing participants and/or professional assessors. An average number of tasks per crowd-sourcing participant and/or professional assessor can be around 200. There can be set up “honey pot” tasks for verifying quality of assessment, which number of honey pots can be around 1900.

Object Feature Vector 308 Generation

The object feature vector 308 can be based on standard ranking features, such as but not limited to: text and link relevance, query characteristics, document quality, user behavior features and the like.

In addition to the ranking features, the object feature vector 308 can be based on the label features associated with the given label 306—numerical information associated with the assessor/crowd-sourced participant who assigned the label 306, numeric value representative of the task; numeric value associated with the label 306 itself, etc.

While a specific choice of label features is also not particularly limited, a general purpose of label features is to provide an approximation of the given label 306 being correct. To generate features for labels 306, the training server 130 can utilize classical consensus models.

Remapping and Reweighting Functions; MLA Training

In some embodiments the calculation of the weight parameter and the relevance parameter is executed by respectively a reweighting function and a remapping function.

In accordance with embodiments of the present technology, the training server 130 executes the reweighting function and the remapping function as follows.

Within the below, the following notations will be used.
X is the training dataset 202 labeled via a crowd-sourcing platform (i.e. using crowd-sourcing participants) or by professional assessors, where:
   X^{TARGET} is a portion of the training dataset 202 that is correctly labelled for the purposes of training (such as that portion of the training dataset 202 marked by professional assessors used for the validation sub-phase 284).
   X^{SOURCE} is a portion of the training dataset 202 that has raw version of the labels 306.
   S^{TRAIN} is a portion of the training dataset 202 that with processed weight parameter and relevance parameter, i.e. containing an output of P (below).
N is a number of query-document features for training objects 204, 206, 208 within the training dataset 202.
M is the number of label features for training objects 204, 206, 208 in the training dataset 202.
S is the number of training objects 204, 206, 208 in the training dataset 202.
X₁ is the vector of ranking query-document features of a given training object 204, 206, 208 (i.e. i∈X of the training dataset 202).
yᵢ is the vector of label features of a given training object 204, 206, 208 (i.e. i∈X training dataset 202).
P is the algorithm for pre-processing of raw training objects 204, 206, 208 into processed training objects 204, 206, 208 (i.e. reweighted and remapped training objects).
R is the MLA used by the ranking application 160.
μ is L₂-regularization parameter of the reweighting and remapping functions.
F_{A} is the ranker trained using the R algorithm.
α is an M-dimensional column vector of weight parameter.
β is an an M-dimensional column vector of the label parameters used in the P.
wᵢ is a weight parameter of a given training objects 204, 206, 208 (i.e. i∈X).
lᵢ is a remapped label of the given training object 204, 206, 208 (i.e. i∈X).
X is an S×N matrix of ranking features for X.
Y is an S×M matrix of relevance value label features for X.
W is a S×S diagonal matrix with weights wᵢ.
l is a S-dimensional column vector of labels Iᵢ.
b is an N-dimensional column vector of parameters of a linear ranker.

Let S be the number of training objects 204, 206, 208 in the training dataset 202 (X), while the training dataset 202 (X) is an S×N matrix with the i-th row x₁ representing query-document features of the i-th training object 204, 206, 208. Let Y be the S×N matrix with the i-th row y₁ representing label features of the i-th training object 204, 206, 208. Let l be a column vector of labels {lᵢ=σ(β·yᵢ)} in the training dataset 202 (X) and W to be the diagonal S×S matrix with {wᵢ=σ(α·yᵢ)}.

In accordance with the embodiments of the present technology, the training server 130 executes the following calculation routines.

The problem to train the ranking application 160 an be expressed as follows:

[symbol]

_{A}(x)=x·b, where

b=(X^{T}WX+μI_{N})⁻¹X^{T}WL. (Formula 1)

Now: Z:=(X^{T}WX+μI_{N}) and let \hat{l}:=X·b be the column vector of values of the ranker

F_{A} on the training dataset 202. Differentiating the equation X^{T}Wl=Zb with respect to αᵢ, the following is derived:

$${X}^{T} \frac{\partial W}{\partial {α}_{j}} l = \frac{\partial Zb}{\partial {α}_{j}} = \frac{\partial Z}{\partial {α}_{j}} b + Z \frac{\partial b}{\partial {α}_{j}} == {X}^{T} \frac{\partial W}{\partial {α}_{j}} Xb + Z \frac{\partial b}{\partial {α}_{j}} = {X}^{T} \frac{\partial W}{\partial {α}_{j}} \hat{l} + Z \frac{\partial b}{\partial {α}_{j}} . \qquad ( Formula 2 )$$

A manipulation to Formula 2 provides:

$$\frac{\partial B}{\partial {β}_{j}} = {Z}^{- 1} {X}^{T} W \frac{\partial l}{\partial {β}_{j}} \qquad ( Formula 3 )$$

Computation of derivatives of b with respect to β from Formula 1 can be executed as follows:

$$\frac{\partial b}{\partial {β}_{j}} = {Z}^{- 1} {X}^{T} W \frac{\partial l}{\partial {β}_{j}} \qquad ( Formula 4 )$$

Given these expressions, it is possible to compute the derivatives of the objective function μ with respect to parameters of the processing step α (α1 . . . , α_{M}) and similarly β (1 . . . , β_{M}):

$$\frac{\partial }{\partial {α}_{j}} = {\sum }_{l ∈ {x}^{target}} {x}_{i} \cdot \frac{\partial b}{\partial {α}_{j}} \frac{\partial }{\partial {s}_{i}} \\ \frac{\partial }{\partial {β}_{j}} = {\sum }_{l ∈ {x}^{target}} {x}_{i} \cdot \frac{\partial b}{\partial {β}_{j}} \frac{\partial }{\partial {s}_{i}} \qquad ( Formula 5 )$$

Where

$$\frac{\partial }{\partial {s}_{i}}$$

stands for the LambdaRank gradient and the sum is taken over all training objects 204, 206, 208 i in the training dataset 202.

A non-limiting example of an algorithm for training the processing step P is summarized below, as a pseudo-code. The initial values of parameters α⁰ correspond to the all unit weights and the initial value β⁰ corresponds to the relevance values Iᵢ, coinciding with the labels cl^{(ω)}.

(Algorithm 1)

Input: matrices X, Y, vector of crowd labels cl, target dataset χ^{target}
labeled by professional assessors.
Parameters: number of iterations J, step size regulation ε, parameter of L₂
regularization μ.
Initialization: α = α⁰, β = β⁰, l = cl, W = Id.
for j = 0 to J do

| | |
|---|---|
| \| | ${Δ}_{α} = {\sum }_{i ∈ {x}^{target}} {x}_{i} \cdot \frac{\partial b}{\partial {α}_{j}} \frac{\partial ℳ}{\partial {s}_{i}}$ |
| \| | ${Δ}_{β} = {\sum }_{i ∈ {x}^{target}} {x}_{i} \cdot \frac{\partial b}{\partial {β}_{j}} \frac{\partial ℳ}{\partial {s}_{i}} , ( see ( 9 ) )$ |
| \| | α^{j+1} = α^{j} + εΔ_{α}; |
| \| | β^{j+1} = β^{j} + εΔ_{β}; |
| \| | Update W, l, b, |

end
for i ∈ x^{source} do

| | |
|---|---|
| \| | ωᵢ = σ(α^{J} · yᵢ); |
| \| | lᵢ = σ(β^{J} · yᵢ); |

End
Output: x^{train}

In accordance to embodiments of the present technology, the so outputted reweighted and remapped training dataset 202 with the associated weight parameters and the associated relevance parameters can be used directly to train the ranking application 160.

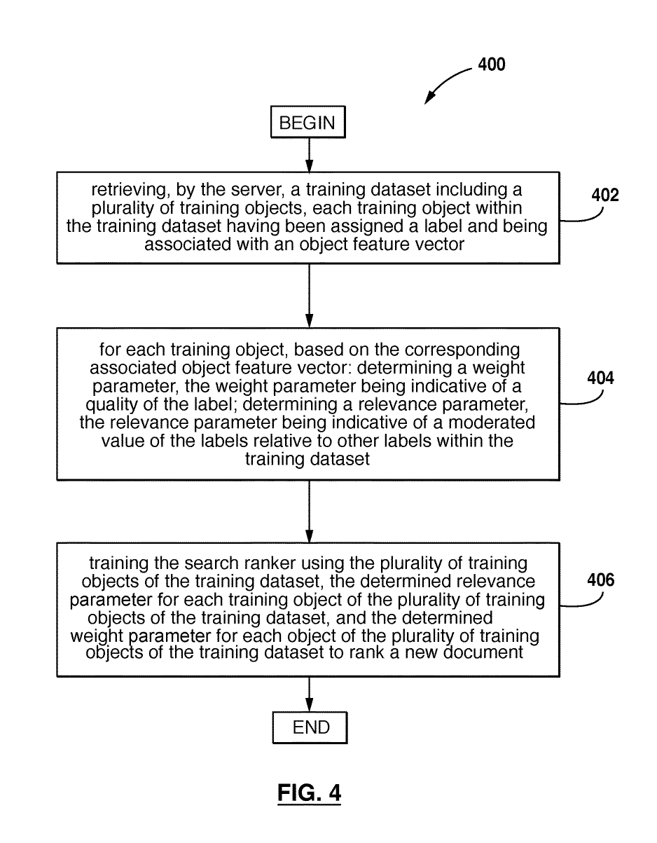

Given the architecture and examples provided herein above, it is possible to execute a computer-implemented method for training a search ranker (such as the ranking application 160), the search ranker being configured to ranking search results. With reference to FIG. 4, there is depicted a flow chart of a method 400, the method 400 being executable in accordance with non-limiting embodiments of the present technology. The method 400 can be executed by the training server 130.

Step 402—retrieving, by the server, a training dataset including a plurality of training objects, each training object within the training dataset having been assigned a label and being associated with an object feature vector

The method 400 starts at step 402, where the training server 130 retrieves a training dataset including a plurality of training objects, each training object within the training dataset having been assigned a label and being associated with an object feature vector.

In certain embodiments of the method 400, the training dataset 202 is a crowd-sourced training dataset.

In certain embodiments of the method 400, the training dataset 202 is a crowd-sourced training dataset and wherein each training object 204, 206, 208 within the training dataset 202 has been assigned the label by a crowd-sourcing participant.

In certain embodiments of the method 400, the object feature vector is based, at least in part, on data associated with the crowd-sourcing participant assigning the label to a given training object 204, 206, 208. In certain embodiments of the method 400, the data is representative of at least one of: browsing activities of the crowd-sourcing participant, time interval spent reviewing the given training object, experience level associated with the crowd-sourcing participant, a rigor parameter associated with the crowd-sourcing participant.

In certain embodiments of the method 400, the object feature vector is based, at least in part, on data associated with ranking features of a given training object 204, 206, 208. In some embodiments of the present technology, the method 400 further comprises determining the object feature vector.

In some embodiments of the method 400, the method 400 further comprises calculating the object feature vector based on a plurality of object features. The plurality of object features can include at least ranking features and label features, and the method 400 can further include a step of organizing object features in a matrix with matrix rows representing ranking features and matrix columns representing label features. Within these non-limiting embodiments, the step of calculating the object feature vector can comprise calculating an objective feature based on the matrix (see Formula 5 above).

Step 404—for each training object, based on the corresponding associated object feature vector: determining a weight parameter, the weight parameter being indicative of a quality of the label; determining a relevance parameter, the relevance parameter being indicative of a moderated value of the labels relative to other labels within the training dataset

At step 404, for each training object, based on the corresponding associated object feature vector, the training server 130 executes: determining a weight parameter, the weight parameter being indicative of a quality of the label; determining a relevance parameter, the relevance parameter being indicative of a moderated value of the labels relative to other labels within the training dataset.

In certain embodiments of the method 400, the method 400 further comprises learning a relevance parameter function for determining the relevance parameter for each training object 204, 206, 208 using the corresponding associated object feature vector by optimizing a ranking quality of the search ranker.

In certain embodiments of the method 400, method 400 further comprises learning a weight function for determining the weight label for each training object 204, 206, 208 based on the corresponding associated object feature vector by optimizing a ranking quality of the search ranker.

In certain embodiments of the method 400, the relevance parameter is determined by a relevance parameter function; the weight label is determined by a weight function; the relevance parameter function and the weight function having been independently trained.

Step 406—training the search ranker using the plurality of training objects of the training dataset, the determined relevance parameter for each training object of the plurality of training objects of the training dataset, and the determined weight parameter for each object of the plurality of training objects of the training dataset to rank a new document

At step 406, the training server 130 executes training the search ranker using the plurality of training objects of the training dataset, the determined relevance parameter for each training object of the plurality of training objects of the training dataset, and the determined weight parameter for each object of the plurality of training objects of the training dataset to rank a new document.

In certain embodiments of the method 400, the search ranker is configured to execute a machine learning algorithm and wherein training the search ranker comprises training the machine learning algorithm.

In certain embodiments of the method 400, the machine learning algorithm is based on one of a supervised training and a semi-supervised training. In certain embodiments of the method 400, the machine learning algorithm is one of a neural network, a decision tree-based algorithm, association rule learning based MLA, a Deep Learning based MLA, an inductive logic programming based MLA, a support vector machines based MLA, a clustering based MLA, a Bayesian network, a reinforcement learning based MLA, a representation learning based MLA, a similarity and metric learning based MLA, a sparse dictionary learning based MLA, and a genetic algorithms based MLA.

In certain embodiments of the method 400, the training is based on a target of directly optimizing quality of the search ranker.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

Embodiments of the present technology allow to learn reweighting and remapping functions that output more refined weight parameters and relevance parameter by collecting and analyzing information about the assessor (whether the crowd-sourcing participants or professional assessors). Using the weight parameter and the relevance parameter in training of the machine learning algorithm used by the ranking application 160 is believed to increase a better ranking function defined by such machine learning algorithm. Embodiments of the present technology are also believed to directly optimize the quality of the ranking function of the ranking application 160 (unlike the prior art approaches to consensus modelling and noise reduction), as embodiments of the present technology use label features (such as outputs of various consensus models, information about the rankers, information about the task, etc).

It should be expressly understood that not all technical effects mentioned herein need to be enjoyed in each and every implementation of the present technology. For example, implementations of the present technology may be implemented without the user enjoying some of these technical effects, while other implementations may be implemented with the user enjoying other technical effects or none at all.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A computer implemented method for training a search ranker, the search ranker being configured to ranking search results, the method being executable at a server associated with the search ranker, the method comprising:
retrieving, by the server, a training dataset including a plurality of training objects, each training object within the training dataset having been assigned a label and being associated with an object feature vector;
for each training object, based on the corresponding associated object feature vector:
determining a weight parameter, the weight parameter being indicative of a quality of the label;
determining a relevance parameter, the relevance parameter being indicative of a moderated value of the labels relative to other labels within the training dataset;
training the search ranker using the plurality of training objects of the training dataset, the determined relevance parameter for each training object of the plurality of training objects of the training dataset, and the determined weight parameter for each object of the plurality of training objects of the training dataset to rank a new document.

2. The method of claim 1, wherein the training dataset is a crowd-sourced training dataset.

3. The method of claim 1, wherein the training dataset is a crowd-sourced training dataset and wherein each training object within the training dataset has been assigned the label by a crowd-sourcing participant.

4. The method of claim 3, wherein the object feature vector is based, at least in part, on data associated with the crowd-sourcing participant assigning the label to a given training object.

5. The method of claim 4, wherein the data is representative of at least one of: browsing activities of the crowd-sourcing participant, time interval spent reviewing the given training object, experience level associated with the crowd-sourcing participant, a rigor parameter associated with the crowd-sourcing participant.

6. The method of claim 1, wherein the object feature vector is based, at least in part, on data associated with ranking features of a given training object.

7. The method of claim 1, the method further comprising learning a relevance parameter function for determining the relevance parameter for each training object using the corresponding associated object feature vector by optimizing a ranking quality of the search ranker.

8. The method of claim 1, the method further comprising learning a weight function for determining the weight label for each training object based on the corresponding associated object feature vector by optimizing a ranking quality of the search ranker.

9. The method of claim 1, wherein
the relevance parameter is determined by a relevance parameter function;
the weight label is determined by a weight function;
the relevance parameter function and the weight function having been independently trained.

10. The method of claim 1, wherein the search ranker is configured to execute a machine learning algorithm and wherein training the search ranker comprises training the machine learning algorithm.

11. The method of claim 10, wherein the machine learning algorithm is based on one of a supervised training and a semi-supervised training.

12. The method of claim 10, wherein the machine learning algorithm is one of a neural network, a decision tree-based algorithm, association rule learning based MLA, a Deep Learning based MLA, an inductive logic programming based MLA, a support vector machines based MLA, a clustering based MLA, a Bayesian network, a reinforcement learning based MLA, a representation learning based MLA, a similarity and metric learning based MLA, a sparse dictionary learning based MLA, and a genetic algorithms based MLA.

13. The method of claim 1, wherein the training is based on a target of directly optimizing quality of the search ranker.

14. The method of claim 1, further comprising calculating the object feature vector based on a plurality of object features.

15. The method of claim 14, the plurality of object features including at least ranking features and label features, and wherein the method further comprises organizing object features in a matrix with matrix rows representing ranking features and matrix columns representing label features.

16. The method of claim 15, wherein the calculating the object feature vector comprises calculating an objective feature based on the matrix.

17. A training server for training a search ranker, the search ranker server for ranking search results, the training server comprising:
a network interface for communicatively coupling to a communication network;
a processor coupled to the network interface, the processor configured to:
retrieve a training dataset including a plurality of training objects, each training object within the training dataset having been assigned a label and being associated with an object feature vector;
for each training object, based on the corresponding associated object feature vector:
determine a weight parameter, the weight parameter being indicative of a quality of the label;
determine a relevance parameter, the relevance parameter being indicative of a moderated value of the labels relative to other labels within the training dataset;
train the search ranker using the plurality of training objects of the training dataset, the determined relevance parameter for each training object of the plurality of training objects of the training dataset, and the determined weight parameter for each object of the plurality of training objects of the training dataset to rank a new document.
